(19) United States
(12) Patent Application Publication
(10) Pub. No.: US 2026/0220354 A1
(43) Pub. Date: Jul. 30, 2026

(54) DIGITAL FORM GENERATION AND OPTIMIZATION USING LARGE LANGUAGE MODELS

(71) Applicant: Adobe Inc., San Jose, CA (US)

(72) Inventors: Anurag SHARMA, Noida, IN (US); Yash Sanjay BHAVSAR, Noida, IN (US); Salil TANEJA, Noida, IN (US); Navneet AGARWAL, Noida, IN (US); Gaurav AHUJA, Noida, IN (US); Arneh JAIN, Noida, IN (US)

(21) Appl. No.: 19/041,373

(22) Filed: Jan. 30, 2025

(51) Int. Cl. G06F 40/166; G06F 11/34

(52) U.S. Cl. CPC G06F 40/166; G06F 11/3438

(57) ABSTRACT

Some aspects relate to technologies providing a framework for generating and optimizing digital forms. In accordance with some aspects, a digital form is presented to a user, and the interaction of the user with the digital form is monitored to obtain form usage information. The form usage information is then analyzed to determine problems with the form. From this analysis, a form hypothesis is generated using a first set of large language model agents and, based on this form hypothesis, a revised form is generated using a second set of large language model agents. This revised form is then presented to the user.

### BACKGROUND

Computer implemented forms are used in many industries to interact with users. These forms are used to gain new customers, perform services, and typically generate revenue. However, such forms are confusing for users when not laid out well or intuitively organized. One particular challenge is a low conversion rate, where a user begins using a form and then stops before completion, because the form is confusing, is not well laid out, is too long, or for many other reasons. When a user does not complete a web form, data collected can become unreliable and revenue can suffer.

### SUMMARY

Some aspects of the present technology relate to, among other things, using large language models (LLMs) and other generative artificial intelligence (AI) to generate and optimize online computer forms, such as web forms. In accordance with some aspects of the technology described herein, form authors can use a form generation and optimization system to generate form insights, either of new or existing forms, build hypotheses about the forms, and create form variations based on those hypotheses. The form variations are then used in experiments where end-users use the forms to perform various tasks (e.g., searching, enrolling, etc.). The form usage (e.g., the interaction of the end-user with the form) is tracked and monitored and more successful variations are promoted for use in a production system. For example, form variations that increase conversion rates are kept, while those that do not are discarded. By improving forms through ideation, hypothesis, generation, and testing, the overall performance and usability of a system is improved.

In some aspects, a form author uses the form generation and optimization system interactively, iteratively refining a form through different variations and promoting forms and subsets of forms that improve the performance. In some aspects, the form generation and optimization system operates automatically, monitoring form usage, detecting problems, generating variations, testing those variations, and promoting those variations that, for example, improve usability or conversion.

This summary is provided to introduce a selection of concepts in a simplified form that are further described below in the Detailed Description. This summary is not intended to identify key features or essential features of the claimed subject matter, nor is it intended to be used as an aid in determining the scope of the claimed subject matter.

### BRIEF DESCRIPTION OF THE DRAWINGS

The present technology is described in detail below with reference to the attached drawing figures, wherein:

FIG. 1 is a block diagram illustrating an exemplary system for generating and optimizing web forms, in accordance with implementations of the present disclosure;

FIG. 2 is a block diagram illustrating usage of a system for generating and optimizing digital forms, in accordance with implementations of the present disclosure;

FIG. 3 is a block diagram illustrating using a system for generating and optimizing web forms to optimize web forms based on usage, in accordance with implementations of the present disclosure;

FIG. 4 is a block diagram illustrating monitoring form usage used by a system for generating and optimizing web forms, in accordance with implementations of the present disclosure;

FIG. 5 is a block diagram illustrating performing form experimentation in a system for generating and optimizing web forms, in accordance with implementations of the present disclosure;

FIG. 6 is a block diagram illustrating large language model based agents and tools used in a system for generating and optimizing web forms, in accordance with implementations of the present disclosure;

FIG. 7 is a flow diagram showing an example process for generating and optimizing web forms using large language models, in accordance with some implementations of the present disclosure;

FIG. 8 is a flow diagram showing an example process for performing actions to update web forms using large language models, in accordance with some implementations of the present disclosure;

FIG. 9 is a flow diagram showing an example process for performing experimentation to generate and optimize web forms using large language models, in accordance with some implementations of the present disclosure;

FIG. 10 is a flow diagram of an example method for training a large language model, in accordance with some implementations of the present disclosure; and

FIG. 11 is a block diagram of an example computing device suitable for implementing some aspects of the present disclosure.

### DETAILED DESCRIPTION

### Definitions

Various terms are used throughout this description. Definitions of some terms are included below to provide a clearer understanding of the ideas disclosed herein.

As used herein, a “digital form” is a form presented by a computer system using an application, a web page, or some other method that includes fields that are fillable or filled by a user. A digital form may be referred to herein simply as a “form,” as a “web form,” or as a “fillable form.”

As used herein, “conversion” is the process of completing a digital form by, for example, filling all fields in the form and submitting the result.

As used herein, a “conversion rate” is the rate at which a digital form is converted (e.g., completed). Digital forms with a low percentage of conversion where, for example, the user does not complete the form, have a low conversion rate. Digital forms with a high percentage of conversion where, for example, the user does not complete the form, have a high conversion rate.

As used herein, a “form author” is an author of a digital form. In some aspects, the form author interacts with a form generation and optimization system to generate a new form that may be based on an existing form or may be based on a blank form.

As used herein, a “form filler” is a user of a digital form that enters data into the form. Interaction of a form filler with a digital form is monitored and used to generate form usage information.

As used herein, a “form definition” is a specification that defines the structure and behavior of digital form. In some aspects, a “form definition” includes specifications of the fields of a form, the layout of the form, and other such information. In some aspects, the form definition is stored in a form datastore.

As used herein, a “form profile” is a vector representation of a form or section of a form that encapsulates various aspects of the form, ranging from its industry, category, and content.

As used herein, a “hypothesis profile” is a vector representation of a hypothesis that includes an identified problem, a selected hypothesis to address the problem, and a predicted result of performing actions to address the problem.

As used herein, a “form datastore” is a storage system where digital forms and/or form definitions are stored.

As used herein, a “usage datastore” is a datastore where anonymized end-user monitoring data is collected. In some aspects, this data contains detailed insights on user interaction with a given form, including the elements they interact with, buttons they click, and timing information. In some aspects, this is combined with a form definition to derive insights about user interaction with a digital form. The system described herein makes use of this stored data to make queries to derive specific insights from data stored in the usage datastore and to obtain pre-processed aggregate analysis of the usage data via for further analysis by LLMs.

As used herein, “form best practices” are a set of best practices obtained over time that encompass domain expertise and marketing on what constitutes a good form from the perspective of the end-user form-filling experience. These best practices are based on analysis of digital forms with a higher conversion rate.

As used herein, “an analysis engine” is a system that performs analysis based on form usage information, form definitions, and, in some aspects, queries by a form author.

As used herein, “large language model agents” include large language model agents and large language model tools that are used by components of a form generation and optimization system to perform functionality to generate and optimize digital forms. Large language model agents are also referred to herein as “LLM agents,” “large language model agents and tools,” “LLM agents and tools,” “large language model tools,” and “LLM tools.” Specifics of large language model agents are described at least in connection with the descriptions of LLM agents and tools component 122, LLM agents and tools 214, and LLM agents and tools component 602.

As used herein, a “hypothesis engine” is a system that helps to develop a form hypothesis. In some aspects, a hypothesis engine is a chat-based engine that uses natural language processing to help a form author develop a form hypothesis. In some aspects, this form hypothesis is based on a form definition, results from an analysis engine, and other inputs. In some aspects, the hypothesis engine enables the development of a hypothesis about how to change a digital form to increase the conversion rate.

As used herein, an “optimization and variation engine” acts on the hypothesis and generates a list of actions that can be applied to the form. The actions are generated against the form definition by leveraging the developed hypothesis, user intent, best practices, and any additional context or information about the task. This optimization and variation engine can provide various calls to various LLM agents and tools using one or more APIs, depending upon the action.

As used herein, “actions” are operations that are performed against the form definition to generate variations. In some aspects, actions use APIs to perform operations on digital forms.

As used herein, “hypothesis ideation” is a process where a hypothesis component is used to iteratively refine and improve generated form hypotheses. In some aspects, hypothesis ideation is performed automatically. In some aspects, hypothesis ideation is performed, by a form author, using the hypothesis component.

### Overview

Generating and optimizing forms, such as web-based forms, is challenging for many reasons. For example, while it is usually possible to tell whether a user is able to effectively engage with and use a form when the user completes the form, it is considerably more difficult to determine how or why a user is not able to effectively use a form. For example, when a user (also referred to herein as a form filler) begins using a form, finds it difficult to complete at some point in the process for one of several reasons, and exits the form, it is important to know why and also to try to determine how to prevent that. Similarly, when a user begins using a form, finds it difficult to complete, tries to continue, and eventually exits at some other point, it is important to determine where in the form the user began to show frustration. A form that has a large number of incomplete engagements is said to have a low conversion rate.

It is known that web forms are significant for businesses in driving user enrollment and generating revenue. For example, a user that starts and completes an enrollment form for an online service usually becomes a customer. However, a user that does not or cannot complete an enrollment form for an online service usually will not become a customer. However, web forms typically have an industrywide low conversion rate and, as a result, companies need to optimize the web form experience to increase the conversion rate and increase revenue.

A typical way to optimize a web form experience involves a team of business analysts who study and analyze existing end-user form journeys, parse available analytics data, and ideate recommendations relevant to the form to improve the conversion rate. After careful review, a few of these recommendations are selected and made part of an experimentation funnel to measure their effectiveness. Unfortunately, this process is time-consuming and plagued by various inefficiencies at different steps. This process also requires a significant amount of direct human interaction with the form, with the data, and with the recommendations for improvement and optimization. As a result, this process can take many days or weeks to carry out for a single-form journey with no assurance that the new form (e.g., with the new changes) will increase conversion. This slow turnaround makes this process difficult to scale this across multiple forms, across multiple customers, and across multiple business units of a company.

Aspects of the technology described herein use generative artificial intelligence to generate and optimize web forms, enabling faster turnaround by analyzing form usage in real time and leveraging that form usage data to drive hypotheses about form conversion and generate recommendations to improve the form experience. Since the core ideas around recommendations often generalize among different forms within a single business unit, the recommendations can usually be generalized among businesses sharing similar domains (e.g., banking, government, etc.). This commonality provides a good case for leveraging the advances in generative artificial intelligence to solve this problem at scale. This is important because having the capability to effectively analyze, measure, and optimize forms by form authors within the product carries significant value in terms of increasing adoption and driving customer value.

In accordance with some aspects, form authors use natural language processing to interact conversationally with a form generation and optimization system to generate an initial form. The form generation and optimization system is then used to generate insights, develop hypotheses, and create form variations based on the developed hypotheses. These variations are then used in experiments with the end-user form fillers where, for example, some users will use some versions of a form and other users will use other versions of the form. The performance of the experiments is tracked and monitored. Variations that increase conversion rate are promoted, and the experiments'learnings are then used to improve the overall system.

The form generation and optimization system optimizes a form by using targeted recommendations personalized to the form and grounded on available data. As an example, a form for customer enrollment might be initially created based on an existing customer enrollment form. The form generation and optimization system is then used to analyze form usage data (e.g., the interaction of end-users with the form), generate hypotheses about possible problems with the form using large-language model tools and agents, generate recommendations for various actions to address those issues using other large-language model tools and agents, generate form variations (e.g., incorporating the hypotheses), and perform real-world experimentation using those form variations. As described above, form variations that improve usage metrics, such as conversion, are promoted, and form variations that do not improve usage metrics are discarded.

In some aspects, the form generation and optimization system uses real user monitoring (RUM) data collected for the given form, form variations, and other similar forms to generate hypothesis and recommendations. Similarly, in some aspects, the form generation and optimization system uses data from past hypotheses, recommendations, variations, and results to improve hypothesis and recommendations for forms both within an industry and across industries.

The form generation and optimization system described herein provides an end-to-end system that allows form authors and other stakeholders to optimize their web forms for those metrics that are most relevant to them such as, for example, the conversion rate of a form. The form generation and optimization system improves forms by providing a system to rapidly generate hypotheses about forms, provide variations, and iterate continuously to optimize the digital forms. In some aspects, the form generation and optimization system uses several components that are based on generative artificial intelligence systems to rapidly generate hypotheses about forms, provide variations, and iterate continuously to optimize the digital forms. A first generative artificial intelligence component of the form generation and optimization system is a form analysis component that performs analysis on forms based on data collected by monitoring form usage data. A second generative artificial intelligence component of the form generation and optimization system is a form hypothesis component that helps to define and ideate upon hypotheses. These hypotheses form the basis of a form optimization and variation component, a third generative artificial intelligence component of the form generation and optimization system. The form optimization and variation component generates changes to a form based on a set of available actions and a hypothesis. These variations are used for experimentation and targeting using a form experimentation component, which is a fourth generative artificial intelligence component of the form generation and optimization system. The form experimentation component and the other components (e.g., the form analysis component, the form hypothesis component, the form optimization and variation component, and other components) use existing product capabilities when rapidly generating hypotheses about forms, providing variations, experimenting, and iterating continuously to optimize the digital forms. The experiment results from the form experimentation component as well as the hypotheses, form definitions, and variations generated, both productive and not productive, serve as valuable data points to feed back into the system and further improve the quality of future hypothesis generation and recommendations.

The form generation and optimization system described herein uses and/or generates various data items when generating hypotheses about forms, providing variations, experimenting, and iterating continuously to optimize the digital forms. One such data item is a form definition which, in some embodiments, is a JSON-based form definition that defines the structure and behavior of a digital form. Another such data item is a form profile which, in some embodiments, is a vector representation of a form or a section of form that encapsulates various aspects of the form or section. These aspects include, but are not limited to, the content of the form as well as various metadata about the form (e.g., industry, category, etc.). This form profile serves as a helpful way to collect relevant examples of forms for few-shot generation by the various LLM tools and agents. Another such data item is a hypothesis profile, which, in some embodiments, is a vector representation of a hypotheses about a form that encapsulates the insights about the form hypotheses.

As described in more detail below, the form generation and optimization system uses various datastores (or databases) when generating hypotheses about forms, providing variations, experimenting, and iterating continuously to optimize the digital forms. One such datastore is a content store, which is a datastore where a form is stored, either as a completed form, a form definition, or some other such storage method. In some embodiments, the content store is a content management system, such as Adobe® Experience Manager, which stores digital forms and other relevant content. In some embodiments, the content store is any suitable storage system that stores digital forms. Another such datastore is a usage datastore, which stores anonymized end-user monitoring data that is collected during form usage. This usage data contains detailed insights on user interaction with a given form, including the elements they interact with, buttons they click, and timing information. In some embodiments, this usage data is combined with the structured form definition described above to derive insights about the user behavior on the given form. This data is processed to generate aggregated insights (e.g., across several forms). The form generation and optimization system makes use of this stored usage data in several ways. One way this data is used to is to make queries to derive insights about usage data from the usage data store. Another way is to make queries to retrieve the aggregated insights that are used by the various LLM tools and agents described herein to provide further analysis of form usage.

One way that the form generation and optimization system is used is to generate a set of form best practices which, as forms are optimized, is used to provide a corpus of best practices for generating forms. In some aspects, the form best practices generated by the form generation and optimization system is combined with other best practices (e.g., form best practices that encompass domain expertise about forms, market research on what constitutes a good form from the perspective of the end-user form-filling experience, and/or other such data). By following these best practices when generating or optimizing a form, forms have a higher conversion rate.

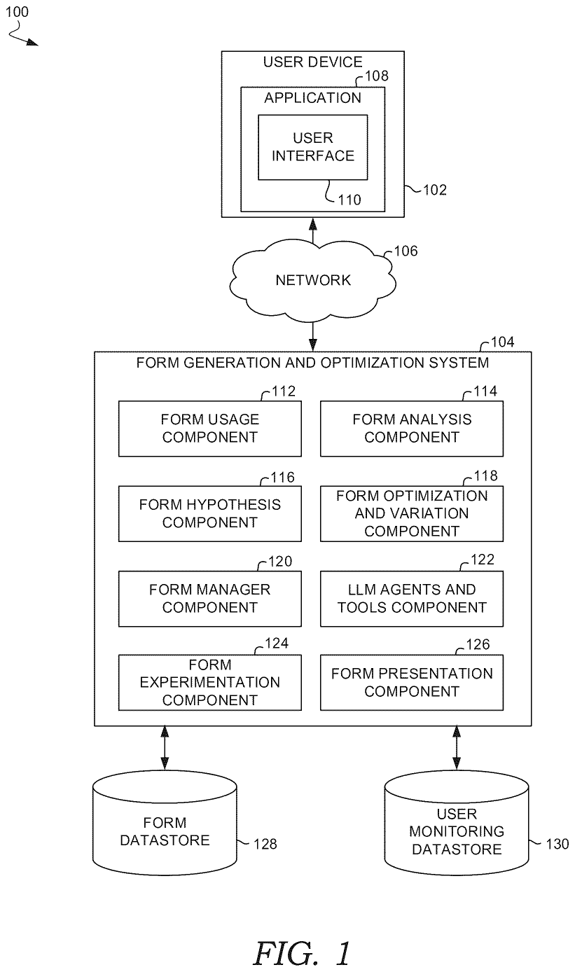

As described in more detail in connection with FIG. 1 below, the form generation and optimization system uses a variety of components including, but not limited to, a form usage component, a form analysis component, a form hypothesis component, a form optimization and variation component, a form manager component, an LLM agents and tools component, a form experimentation component, and a form presentation component. These components are also described in terms of several “engines” that use the various components to perform a variety of actions when generating hypotheses about digital forms, providing variations, experimenting, and iterating continuously to optimize the digital forms. One such engine is an analysis engine that performs analysis based on the ingested usage data, the form definition, and other such data (e.g., a query about a form from a form author). Another such engine is a hypothesis engine. In some embodiments, a hypothesis engine is a chat-based system that helps the form author ideate to develop an optimization hypothesis. The ideation is based on the form definition, the results from the analysis engine, and any form author inputs. This ideation allows the form authors to develop a hypothesis around what change must be made to the form to increase the conversion rate. In some embodiments, a hypothesis engine is used by the form generation and optimization system to automatically generate hypothesis, as described below. Another such engine is an optimization and variation engine that uses a generated hypothesis to generate a list of actions that are applied to the form. The actions are generated against the form definition by leveraging the developed hypothesis, user intent, best practices, and any additional context or information about the task. The process of generating actions can involve various additional specific LLM calls depending upon the action. For example, a field enhancer tool (described below) is used to enhance a given field by generating placeholder values for a collection of fields. In some aspects, a user (e.g., the form author) is kept in the loop during the process and can choose which actions to apply. In some aspects, the form generation and optimization system determines which actions to apply based on, for example, best practices. These actions form the basis for generating the form variations.

As used herein, the actions are a library of operations that are performed by the form generation and optimization system against the form definition to generate variations. In some aspects, actions use application programming interfaces (APIs) of a form manager to perform operations on form fields and form panels, component variations, styling changes, etc. In some embodiments, the form generation and optimization system can provide recommendations that are not immediately actionable directly (e.g., by an available API) but that is leveraged (e.g., by the system and/or the form authors) to improve the form in other ways.

Aspects of the technology described herein provide a number of improvements over existing technologies. For example, using the form generation and optimization system to generate hypotheses about forms, provide variations, perform experiments, and iterate continuously to optimize the digital forms provides a significantly faster and more accurate way to detect issues with digital forms and address those issues. Typical existing methods require considerable human interaction, manual experimentation and analysis within a closed (e.g., non-production) system, slow and potentially non-productive hypotheses and variations, and eventual migration of a new form variation to a production system. Such typical methods can take many days, resulting in a considerable amount of lost customers and revenue and an even more considerable cost in human time and the use of computational resources.

Aspects of the technology described herein provide a number of improvements to computer systems by enabling both more efficient data collection (e.g., of data collected from form fillers using the forms) and more efficient form processing. For example, an existing form with a low conversion rate due to a form filler does not complete the form. Examples of reasons why a form filler does not complete a form range from confusion about how to fill in the various form fields, length of the form, or other factors. For example, a form can have a “More Information” button that, when pressed, takes a form filler away from the form. Form usage data can then indicate that users frequently do not return to the form after that, resulting in low conversion rates. A form that is started but not completed wastes computing resources by attempting to gather data that will be incomplete, and thus of limited utility. Similarly, a form that is long or confusing can also have incomplete or erroneous data. Using a form generation and optimization system to continuously analyze forms, hypothesize about the form, generate actions, and provide revisions, causes individual forms to be made more efficient and data collection from those forms is improved. Similarly, using a form generation and optimization system more efficiently uses computing system resources by increasing conversion and improving the quality of gathered data that is used by stakeholders in the form to generate derived data about customers.

As may be contemplated, while the technology described herein is described in terms of digital forms, or web forms, or forms, the technology described herein is used in any data gathering process where a user (e.g., a form filler) enters data that is used to generate insights that then are used to inform decisions. Elements of a form generation and optimization system can, for example, be used to gather usage data for any interactive data gathering process, to determine possible issues, to generate hypotheses about those issues, to generate actions to address those issues, and to generate variations in the data gathering tools that improve the data gathering process.

### Example System and Methods for Generating and Optimizing Digital Forms

With reference now to the drawings, FIG. 1 is a block diagram illustrating an exemplary system 100 for generating and optimizing web forms, in accordance with implementations of the present disclosure. It should be understood that this and other arrangements described herein are set forth only as examples. Other arrangements and elements (e.g., machines, interfaces, functions, orders, and groupings of functions, etc.) is used in addition to or instead of those shown, and some elements is omitted altogether. Further, many of the elements described herein are functional entities that is implemented as discrete or distributed components or in conjunction with other components, and in any suitable combination and location. Various functions described herein as being performed by one or more entities is carried out by hardware, firmware, and/or software. For instance, various functions are carried out by a processor executing instructions stored in memory.

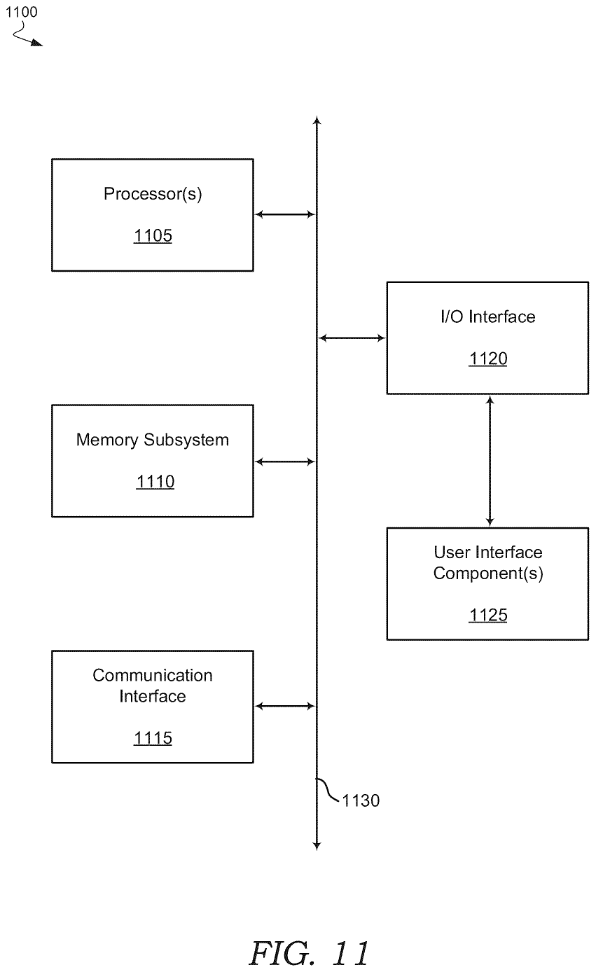

The system illustrated in block diagram 100 is an example of a suitable architecture for implementing certain aspects of the present disclosure. Among other components not shown, the system illustrated in block diagram 100 includes a user device 102 and a form generation and optimization system 104. Each of the user device 102 and the form generation and optimization system 104 shown in FIG. 1 can comprise one or more computer devices, such as the computing device 1100 of FIG. 11, described below. As shown in FIG. 1, the user device 102 and the form generation and optimization system 104 can communicate via a network 106, which may include, without limitation, one or more local area networks (LANs) and/or wide area networks (WANs). Such networking environments are commonplace in offices, enterprise-wide computer networks, intranets, and the Internet. It should be understood that any number of user devices and servers may be employed within the system illustrated in block diagram 100 within the scope of the present technology. Each device or server may comprise a single device or multiple devices cooperating in a distributed environment. For instance, the form generation and optimization system 104 may be provided by multiple server devices collectively providing the functionality of the form generation and optimization system 104, as described herein. Additionally, other components not shown may also be included within the environment.

The user device 102 is a client device on the client-side of the operating environment illustrated in block diagram 100, while the form generation and optimization system 104 is on the server-side of the operating environment illustrated in block diagram 100. The form generation and optimization system 104 can comprise server-side software designed to work in conjunction with client-side software on the user device 102 so as to implement any combination of the features and functionalities discussed in the present disclosure. For example, the user device 102 can include an application 108 for interacting with the form generation and optimization system 104. The application 108 is, for instance, a web browser or a dedicated application for providing functions, such as those described herein. This division of an operating environment illustrated in block diagram 100 is provided to illustrate one example of a suitable environment. There is no requirement for each implementation that any combination of the user device 102 and the form generation and optimization system 104 remain as separate entities. While the operating environment illustrated in block diagram 100 illustrates a configuration in a networked environment with a separate user device 102 and form generation and optimization system 104, it should be understood that other configurations is employed in which aspects of the various components are combined. For instance, in some aspects, aspects of the form generation and optimization system 104 is implemented in part or in whole by the user device 102.

In some configurations, the application 108 can comprise a user interface 110. In some configurations, the user interface 110 provides one or more user interfaces to a user of a device, such as the user device 102 for interacting with the form generation and optimization system 104. In some instances, the user interface 110 is presented on the user device 102 via the application 108, which is a web browser or a dedicated application for interacting with the form generation and optimization system 104. For instance, the user interface 110 can provide user interfaces for, among other things, receiving input from a user and providing responses to the user. It should be noted that, while the user interface 110 is shown as an element of application 108, in some embodiments, the form generation and optimization system 104 further includes a user interface component (not shown in FIG. 1) that provides one or more user interfaces for interacting with the form generation and optimization system 104. In some aspects, not shown in FIG. 1, a user interface component provides one or more user interfaces to a user device, such as the user device 102 via the application 108.

The user device 102 may comprise any type of computing device capable of use by a user. For example, in one aspect, a user device may be the type of computing device 1100 described in relation to FIG. 11 herein. By way of example and not limitation, the user device 102 may be embodied as a personal computer (PC), a laptop computer, a mobile or mobile device, a smartphone, a tablet computer, a smart watch, a wearable computer, a personal digital assistant (PDA), an MP3 player, global positioning system (GPS) or device, video player, handheld communications device, gaming device or system, entertainment system, vehicle computer system, embedded system controller, remote control, appliance, consumer electronic device, a workstation, or any combination of these delineated devices, or any other suitable device. A user may be associated with the user device 102 and may interact with the form generation and optimization system 104 via the user device 102.

In some configurations, the form generation and optimization system 104 may be implemented, at least in part, using artificial intelligence models that generate responses to user queries through natural language interaction. In such instances, the form generation and optimization system 104 can use artificial intelligence and machine learning algorithms to understand user queries, interpret context, and generate responses by accessing relevant information from various sources. In at least one embodiment, the form generation and optimization system 104 uses generative models such as those described herein to understand user queries, interpret context, and generate and optimize web forms using systems, methods, operations, and techniques such as those described herein.

In some aspects, the form generation and optimization system 104 receives digital form usage data, analyzes that usage data to determine possible usage problems, generates hypotheses using insights gained from that usage data, generates actions to address those hypothesis, and generates a variation of the form based on those actions. The form generation and optimization system 104 receives the usage data by monitoring form usage. The form generation and optimization system 104 then analyzes the form usage data (e.g., the interaction of end-users with the form), generates hypotheses about possible problems with the form using large-language model tools and agents, generates recommendations for various actions to address those issues using other large-language model tools and agents, generates form variations (e.g., incorporating the hypotheses), and performs real-world experimentation using those form variations. As described above, form variations that improve usage metrics such as conversion are promoted and form variations that do not improve usage metrics are discarded.

As shown in FIG. 1, the form generation and optimization system 104 comprises a form usage component 112, a form analysis component 114, a form hypothesis component 116, a form optimization and variation component 118, a form manager component 120, an LLM agents and tools component 122, a form experimentation component 124, and/or a form presentation component 126. The components of the form generation and optimization system 104 are in addition to other components that provide further additional functions beyond the features described herein. The form generation and optimization system 104 is implemented using one or more server devices, one or more platforms with corresponding application programming interfaces, cloud infrastructure, and the like. While the form generation and optimization system 104 is shown as separate from the user device 102 in the configuration of FIG. 1, it should be understood that in other configurations, some or all of the functions of the form generation and optimization system 104 is provided on the user device 102. Additionally, in some configurations, one or more of the components of the form generation and optimization system 104 shown in FIG. 1 (e.g., the form usage component 112, the form analysis component 114, the form hypothesis component 116, the form optimization and variation component 118, the form manager component 120, the LLM agents and tools component 122, the form experimentation component 124, and/or the form presentation component 126) is provided by the user device 102 and/or another device not shown in FIG. 1. In some configurations, the components of the form generation and optimization system 104 is provided by a single entity or by multiple entities.

In some aspects, the form generation and optimization system 104 presents a fillable form using a user interface (e.g., using the form presentation component 126 and the user interface 110), monitors user interaction with the fillable form to obtain form usage information (e.g., using the form usage component 112), analyzes the form usage information to determine usage problems (e.g., using the form analysis component 114 and the LLM agents and tools component 122), generates a hypothesis to improve the fillable form using LLM agents and tools (e.g., using the form hypothesis component 116 and the LLM agents and tools component 122), generates a revised form based on the hypothesis to improve the fillable forms (e.g., using the form optimization and variation component 118 and the LLM agents and tools component 122), and presents the revised form using the user interface (e.g., again using the form presentation component 126 and the user interface 110). In some aspects, the form generation and optimization system 104 performs experiments using form variations (e.g., using the form experimentation component) by further monitoring user interaction with the fillable form to obtain form usage information (e.g., using the form usage component 112). In some aspects, when the form generation and optimization system 104 generates a revised form based on the hypothesis to improve the fillable forms (e.g., using the form optimization and variation component 118 and the LLM agents and tools component 122), the form generation and optimization system 104 generates one or more actions, as described above, based on the hypothesis that, if performed on the form (or the form definition), will generate the revised form.

In some aspects, the functions performed by the components of the form generation and optimization system 104 are associated with one or more applications, services, or routines. In particular, such applications, services, or routines may operate on one or more user devices and servers, may be distributed across one or more user devices and servers, or may be implemented in the cloud. Moreover, in some aspects, these components of the form generation and optimization system 104 may be distributed across a network, including one or more servers and client devices, in the cloud, and/or may reside on a user device. Moreover, these components, functions performed by these components, or services carried out by these components may be implemented at appropriate abstraction layer(s) such as the operating system layer, application layer, hardware layer, etc., of the computing system(s). Alternatively, or in addition, the functionality of these components and/or the aspects of the technology described herein is performed, at least in part, by one or more hardware logic components. For example, and without limitation, illustrative types of hardware logic components that is used include Field-programmable Gate Arrays (FPGAs), Application-specific Integrated Circuits (ASICs), Application-specific Standard Products (ASSPs), System-on-a-chip systems (SOCs), Complex Programmable Logic Devices (CPLDs), etc. Additionally, although functionality is described herein with regards to specific components shown in the example system illustrated in block diagram 100, it is contemplated that in some aspects, functionality of these components is shared or distributed across other components.

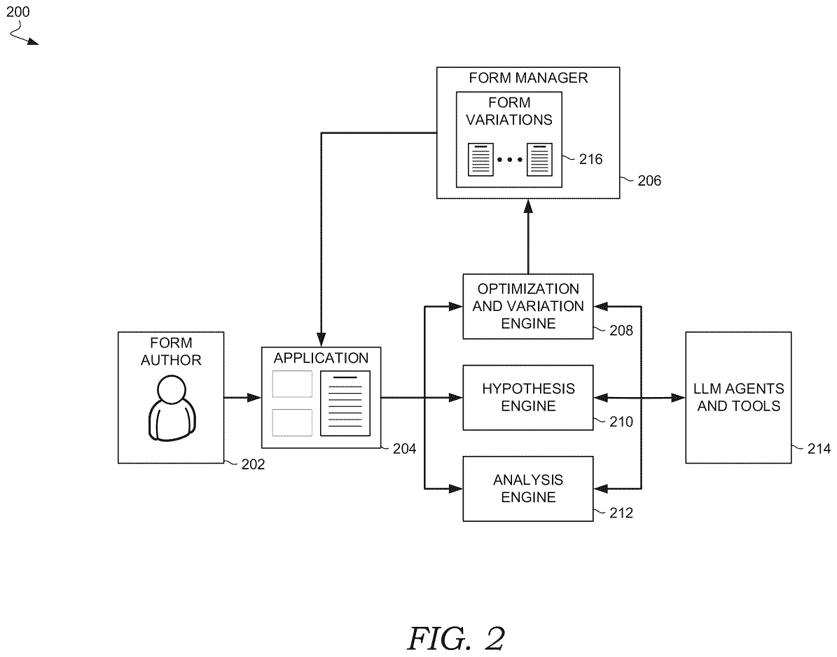

Given an input from a user device (e.g., user device 102) to generate and/or optimize a web form, the form generation and optimization system 104 uses the form presentation component 126 to present the form or the form definition to a user, using the user interface 110. The form presentation component 126 receives a form definition (e.g., as described herein) and performs operations to display the form to the user by, for example, rendering the form using a variety of API calls. In some aspects, there is no specific input from the user device to generate and/or optimize a web form and, in such aspects, the form generation and optimization system 104 uses the form presentation component 126, described herein, to present an existing form which will be automatically optimized using the components of the form generation and optimization system 104. In some aspects, the form presentation component 126 receives, as input, an indication of a form to generate and/or optimize. In some aspects, the indication of the form to generate and/or optimize is provided as input from a user of user device 102, using user interface 110 of application 108 using, for example, a form definition as described herein. In some aspects, the indication of the form to generate and/or optimize is obtained from a datastore such as form datastore 128, which contains a library of existing forms. As used herein, the form datastore 128 is a structured datastore that includes form definitions stored so that they are retrieved or otherwise accessed by user device 102, using user interface 110 of application 108. The form definitions of the form datastore 128 can also be retrieved or otherwise accessed by other components of the form generation and optimization system 104. When the input from the user device 102 is to generate a digital form, the form definition used by the form presentation component 126 is a definition of a blank form, or is a definition of an existing form (e.g., retrieved from datastore 128) that serves as a basis for a new form. As described herein, the form presentation component 126 is used by, or in conjunction with, a number of components of the form generation and optimization system 104. Further details of the form presentation component 126 are described below, in connection with FIGS. 2-5.

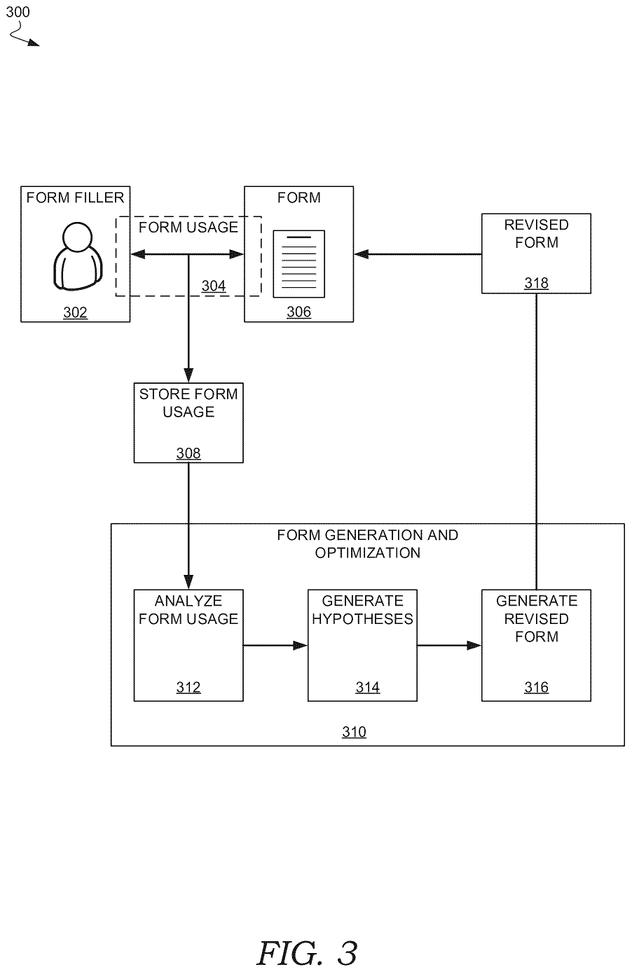

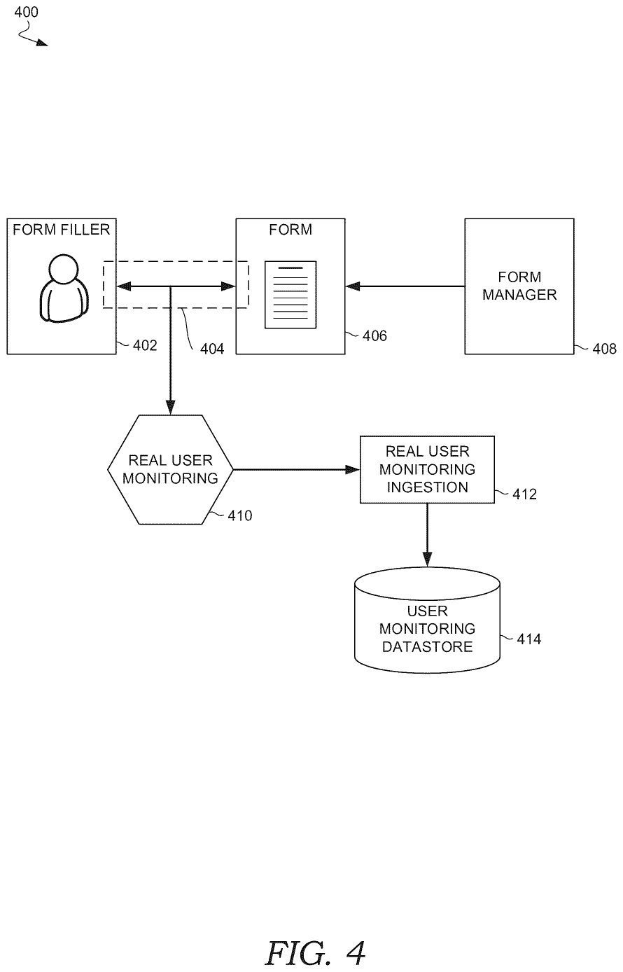

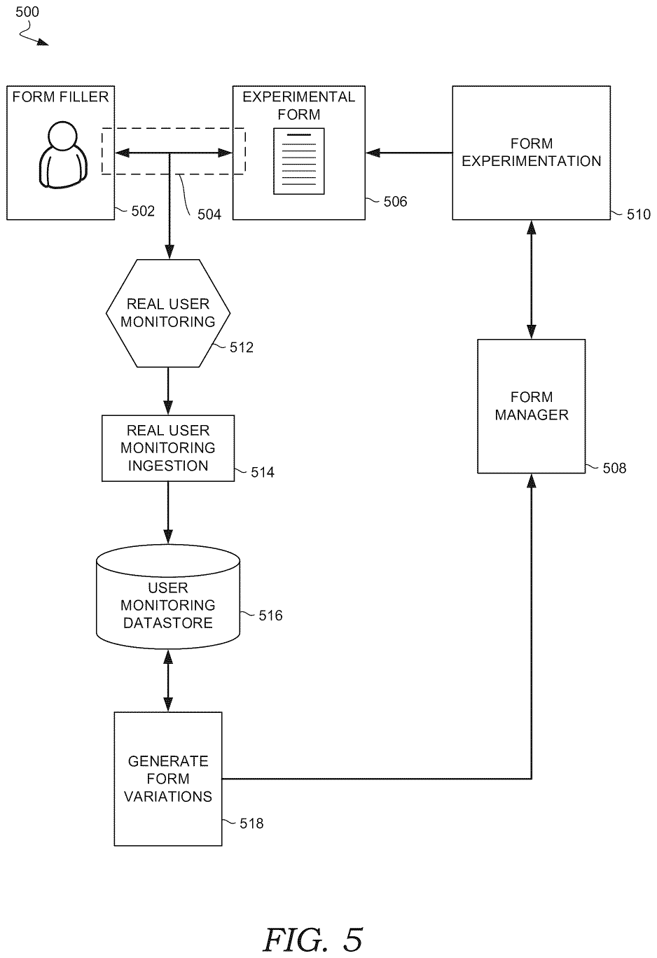

Given an indication of a form to generate and/or optimize the form generation and optimization system 104 uses the form usage component 112 to monitor and store usage data such as the interactions of a user of the user device 102 with the indicated form. In some aspects, the form usage component 112 performs real user monitoring (RUM) and ingests the real user monitoring data into a user monitoring datastore 130, as described at least in connection with FIGS. 4 and 5. As with the form datastore 128, described above, the user monitoring datastore 130 is a structured datastore that stores form usage data (e.g., button presses, field entries, timing, etc.) so that the usage data is retrieved or otherwise accessed by other components of the form generation and optimization system 104. As described herein, the form usage component 112 is used by, or in conjunction with, a number of components of the form generation and optimization system 104. Further details of the form usage component 112 are described below, in connection with FIGS. 3-5.

Given the form usage data obtained by the form usage component 112, the form generation and optimization system 104 uses the form analysis component 114 to analyze the form usage data. The form analysis component 114 obtains the form usage data from the user monitoring datastore 130 and uses various agents and tools of the LLM agents and tools component 122 (described below) to analyze the form usage to identify problems or issues with the presented form. The form analysis component 114 uses agents and tools of the LLM agents and tools component 122 to, for example, identify a pattern of usage where a form filler typically leaves a form after clicking on a “More Information” button or to identify a pattern of usage where a form filler rarely comes back to complete a form after saving the form to complete later. The form analysis component 114 will use the agents and tools of the LLM agents and tools component 122 and generate a report of one or more problems or issues with a form. Further details of the form analysis component 114 and the associated analysis engine are described below, in connection with FIGS. 2 and 3.

Given the problems and/or issues identified by the form analysis component 114, the form generation and optimization system 104 uses the form hypothesis component 116 to formulate one or more hypotheses about the form. The form hypothesis component 116 uses the problems and/or issues identified by the form analysis component 114 and uses various agents and tools of the LLM agents and tools component 122 (described below) to generate hypotheses about the form. A hypothesis about the form is the first step in the optimization process, but can also be the first step in a process to generate a form since a form that is optimized as it is generated is a more efficient form. A form hypothesis generated by the form hypothesis component 116 typically includes an identification of some aspect of the form that is leading to a low conversion rate, a negative user experience, or faulty data as revealed by the form analysis component 114. A form hypothesis generated by the form hypothesis component 116 also typically includes a proposed change to the form that is used to address the identified aspect of the form. A form hypothesis generated by the form hypothesis component 116 also typically includes the expected result of the proposed change to the form and how that proposed change will impact the identified aspect of the form. An example form hypothesis generated by the form hypothesis component 116 is “many users (over 60%) who click on the ‘more information’ button on the form do not complete the form and removing this button could help to keep the users engaged with the form and increase the chances that they will complete the form.”

Using the results of the form analysis component 114 to generate the hypothesis by the form hypothesis component 116 using various agents and tools of the LLM agents and tools component 122 makes generating a well-defined and accurate hypothesis an easier and more efficient process. Absent such components, generating a hypothesis is challenging since analyzing usage data (including both real user monitoring data and historical data about similar forms) is labor intensive and generating a hypothesis can depend on many factors (e.g., form definition, target audience, context, etc.). Additionally, generating a new form is more challenging because there is a lack of such data. Using the agents and tools of the LLM agents and tools component 122 to generate the hypothesis reduces this challenge. Modern LLMs have a rich generalization capability, allowing them to apply concepts learned from one domain to another. This rich generalization capability is leveraged to mitigate many of the challenges described. In some aspects, form authors can interact conversationally with the form hypothesis component 116 of the form generation and optimization system 104 to generate and develop a hypothesis by guiding the LLM agents and tools. In some aspects, prompts to the LLM agents and tools are generated automatically by the form hypothesis component 116. As described herein, the form hypothesis component 116 uses all available information, including the form definition, and end user historical analytics data, older hypothesis, etc., to simplify the generation and increase the relevance of the hypothesis. The form hypothesis component 116 and the associated hypothesis engine are described in more detail in connection with FIG. 2.

Given the form hypotheses generated by the form hypothesis component 116, the form generation and optimization system 104 uses the form optimization and variation component 118 to optimize the form by generating one or more form variations based on actions that is taken to address the form hypotheses. For example, with the form hypothesis that “many users (over 60%) who click on the ‘more information’ button on the form do not complete the form and removing this button could help to keep the users engaged with the form and increase the chances that they will complete the form,” an identified action is to “remove the ‘more information’ button,” and the form optimization and variation component 118 uses this action to generate a form variation that has the “more information” button removed from the form. The form optimization and variation component 118 uses the agents and tools of the LLM agents and tools component 122 to generate form variations based on actions that is taken to address the form hypotheses as described below in connection with FIGS. 2-5.

Given the one or more form variations generated by the form optimization and variation component 118, the form experimentation component 124 presents the form variations using the form presentation component 126 and gathers usage data, using the form usage component 112 as described herein. Results of the experiments performed on the variations using the form experimentation component are further evaluated using the form analysis component 114, causing the form generation and optimization system 104 to iteratively optimize the digital forms. The form experimentation component 124 is described in more details in connection with FIG. 5.

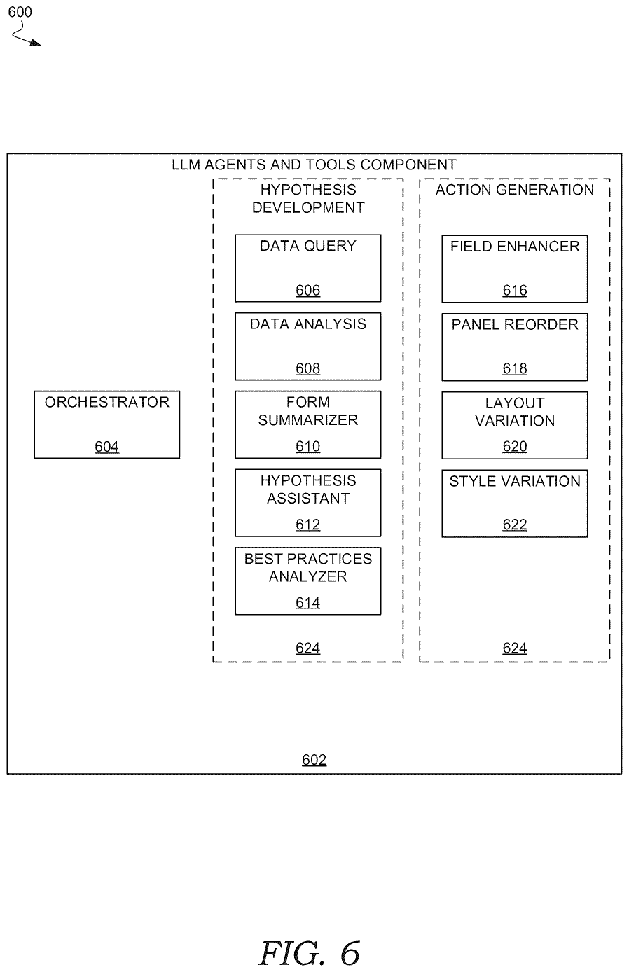

Other components of the form generation and optimization system 104 include the form manager component 120, which is a content manager that stores and manages forms and the LLM agents and tools component 122, which provides a number of LLM based agents and tools that are used by the other components of the form generation and optimization system 104 to generate and optimize digital forms. The form manager component 120 is a content management system that stores and manages form definitions including definitions of existing forms, definitions of form variations (both successful and not), definition of historical forms, and other such form data. The various LLM agents and tools of the LLM agents and tools component 122 are described below, in connection with FIG. 6.

Although not shown in FIG. 1, the form generation and optimization system 104 uses the LLM agents and tools component 122 to evaluate the relevance of hypotheses generated by the form hypothesis component 116, based on any actions performed by the form optimization and variation component 118, and any experiments performed by the form experimentation component 124. In one aspect, a few-shot generation technique is used that uses examples of hypotheses retrieved using retrieval augmented generation (RAG) to ensure the relevance of the generated hypotheses. This few-shot generation technique first stores data related to the hypothesis in a vector store (not shown in FIG. 1). This data includes a form profile that comprises a form definition, a hypothesis, any actions performed, and the results of any experiments performed and a hypothesis profile that also comprises the form definition, the hypothesis, any actions performed, and the results of any experiments performed. In order to improve the relevance of retrieved samples, embeddings generated from embedding models (e.g., Azure Open AI text-embedding-3-small) are transformed with standard techniques leveraging contrastive loss to bring the embeddings of a form profile and a corresponding hypothesis profile closer while distancing the embeddings of unrelated pairs. This helps ensure that relevant examples are selected in order to develop the initial hypothesis for the given form, and also to ensure that the examples get updated as the hypothesis is updated. In some aspects, the initial examples within the vector store are generated based on experiences and known best practices. As users use the form generation and optimization system 104 to generate hypotheses and variations for different forms, successful data points will be added to the vector store, enriching the few-shot examples sent to the LLMs.

In some aspects, generative AI models such as the LLMs described herein comprise multi-modal language models that includes a set of statistical or probabilistic functions to perform natural language processing (NLP) in order to understand and learn prompts used in the form generation and optimization system 104. In some aspects, a generative AI model is a model that is trained to receive text prompts and generate responses based on those prompts. Such generative AI models can use previously trained large language models (LLMs) to process prompts and is trained to generate responses based on a large corpus of data. In some configurations, a LLM can receive input and provide analysis of that input, as described herein. Such models can comprise a deep neural network that is very large (billions to hundreds of billions of parameters) and understands, processes, and produces human natural language by being trained on massive amounts of text.

FIG. 2 is a block diagram 200 illustrating usage of a system for generating and optimizing digital forms, in accordance with implementations of the present disclosure. The system illustrated in FIG. 2 includes a form author 202 which is a user tasked with generating a digital form and, although the form author 202 is shown in FIG. 2, in some aspects, the processes illustrated in FIG. 2 are performed without a form author. The form author 202 uses an application 204 (e.g., an application such as application 108, described in connection with FIG. 1) to generate a digital form. The application 204 uses an analysis engine 212, a hypothesis engine 210, and an optimization, and a variation engine 208 to generate the digital form.

The analysis engine 212 performs operations to analyze form usage data to determine problems or issues with the digital form or fields of the form. The analysis engine 212 is an aspect of the form generation and optimization system 104, described in connection with FIG. 1 that comprises the form analysis component 114. The analysis engine 212 uses LLM agents and tools 214 (e.g., the LLM agents and tools component 122, described in connection with FIG. 1) to analyze form usage data.

The hypothesis engine 210 uses the analysis of the form usage data from the analysis engine 212 to generate form hypotheses, as described above. The hypothesis engine 210 is an aspect of the form generation and optimization system 104, described in connection with FIG. 1 that comprises the form hypothesis component 116. The hypothesis engine 210 also uses the LLM agents and tools 214 to generate form hypotheses.

The optimization and variation engine 208 generates one or more actions based on the form hypotheses generated by the hypothesis engine 210 and uses those actions to generate form variations 216. The optimization and variation engine 208 is an aspect of the form generation and optimization system 104, described in connection with FIG. 1 that comprises the form optimization and variation component 118. The optimization and variation engine 208 also uses the LLM agents and tools 214 to generate form variations 216.

When the optimization and variation engine 208 generates new form variations 216, those form variations are stored using the form manager 206, which is a content management system used to store and manage form definitions. The form manager 206 is an aspect of the form generation and optimization system 104, described in connection with FIG. 1 that comprises the form manager component 120. In some aspects, the form variations 216 are provided to the application 204 for further analysis, hypothesis generation, and optimization.

Although not shown in FIG. 2, data from the hypothesis engine 210 and the optimization engine 208 is used, along with experiment results, to perform hypothesis relevance analysis as described above, in connection with FIG. 1 (e.g., to evaluate the relevance of hypotheses generated by the form hypothesis component 116, based on any actions performed by the form optimization and variation component 118, and any experiments performed by the form experimentation component 124).

Also not shown in FIG. 2, the hypothesis engine 210 uses end-user behavior associated with digital forms obtained via the analysis engine 212. This is done by providing access to tools that can make queries to a data store that collects information about the user behavior on the form (e.g., user monitoring datastore 130). This information includes data about duration of use of the form, drop off rates, error rates, and other such information. In addition to making queries, pre-aggregated query results are also provided to the hypothesis engine 210. These pre-aggregated query results are computed based on a predefined methodology. The hypothesis engine 210 uses this information about user behavior and/or the pre-aggregated query results to provide information that is used to generate a grounded hypothesis.

As described herein, when a hypothesis is generated, the optimization and variations engine 208 creates a variation of the form, using actions based on the hypothesis. The optimization and variations engine 208 uses the hypothesis generated by the hypothesis engine 210 to generate a list of actions (also referred to as recommendations) to apply to the form to generate form variations 216. In some aspects, applying one or more actions to the form definition generates a copy of the form with the variations. In some aspects, alternate actions are used to generate a plurality of form variations 216. For example, an action to move a button to a different location with the form may have a variety of new locations, each of which causing a different form variation to be generated.

Examples of actions that is applied to a form definition include, but are not limited to, field enrichment, form reordering, layout variations, and field variants. Field enrichment actions use a generative AI prompt to generate or update help text associated with a field, generate placeholders to improve the field or the form, update validation expressions for the field, update default values for the field, update formatting for the field, and to perform other such field enrichment operations. Form reordering actions reorder the panels and/or fields within a form to improve the form filling experience. Layout variation actions update data and/or metadata associated with the form layout (e.g., wizards, tabs, responses, etc.) to improve the form filling experience. Field variant actions change the interface component associated with a field (e.g., text boxes, formatted text boxes, sliders, date pickers, drop-downs, etc.) to improve the form filling experience. Other examples of actions than is performed to generate form variations include actions to ensuring that there is a styling consistency within the form and between the form and a parent page, recommending broad visual changes to the form (e.g., background color, text size, etc.) to improve readability or simplify the form filling experience, suggesting default data or intelligent prefilling of fields, etc.

FIG. 3 is a block diagram 300 illustrating using a system for generating and optimizing web forms to optimize web forms based on usage, in accordance with implementations of the present disclosure. Components of a form generation and optimization system 104 described in connection with FIG. 1 collect data of form usage 304 for the usage of a form 306 by a form filler 302. The data of form usage 304 is based on the interaction of the form filler 302 with the form 306 and can include such data as fields used, timing on the data entry, mouse movements, keyboard entries, etc. as well as data about engagement, disengagement, and/or reengagement of the form filler 302 with the form 306. The data of the form usage 304 is stored 308 in a usage datastore (not shown in FIG. 3) such as user monitoring datastore 130, described in connection with FIG. 1. The gathering and storing of the data of the form usage 304 is performed by a form usage component 112, also described in connection with FIG. 1.

The stored 308 form usage data is used to perform form generation and optimization 310, using components of a form generation and optimization engine 104. As illustrated in FIG. 3, form generation and optimization 310 analyzes the form usage data 312 (e.g., using the form analysis component 114), generates hypotheses 314 (e.g., using the form hypothesis component 116), and generates a revised form 316 (e.g., using the form optimization and variation component 118), all as described herein. The revised form 318 is provided using a form presentation component 126 and new data of form usage 304 is then gathered for the new form 318, which replaces the form 306. FIG. 4 provides additional details on how the data of form usage 304 is gathered. FIG. 5 provides additional details on how the data of form usage 304 is used to perform form experimentation that is used to optimized digital forms.

FIG. 4 is a block diagram 400 illustrating monitoring form usage used by a system for generating and optimizing web forms, in accordance with implementations of the present disclosure. Components of a form generation and optimization system 104 described in connection with FIG. 1 collect data of form usage 404 for the usage of a form 406 by a form filler 402. As described in connection with FIG. 3, the data of form usage 404 is based on the interaction of the form filler 402 with the form 406 and can include such data as fields used, timing on the data entry, mouse movements, keyboard entries, etc. as well as data about engagement, disengagement, and/or reengagement of the form filler 402 with the form 406. The form 406 is a provided by a form manager 408, which is an embodiment of the form manager component 120, described in connection with FIG. 1. The data of form usage 404 is collected using real user monitoring 410, which records and analyzes how users interact with an application, or a form, or a website, in real time. Components of the form generation and optimization system 104 described in connection with FIG. 1 perform real user monitoring ingestion 412 to store the data of form usage 404 in a user monitoring datastore 414, which is a user monitoring datastore such as user monitoring datastore 130, described in connection with FIG. 1. In some aspects, not shown in FIG. 4, other components of the form generation and optimization system 104 use the data in the user monitoring datastore 414 to analyze forms, generate hypothesis, select actions, and generate form variations, as described herein.

FIG. 5 is a block diagram 500 illustrating performing form experimentation in a system for generating and optimizing web forms, in accordance with implementations of the present disclosure. A form manager 508 selects a form variation as described above, and performs form experimentation 510 using an experimental form 506 (e.g., a form based on the selected form variation). As described above, the form manager 508 is an embodiment of the form manager component 120 and the form experimentation 510 is performed by an embodiment of the form experimentation component, both described in connection with FIG. 1. Components of a form generation and optimization system 104 described in connection with FIG. 1 collect data of form usage 504 for the usage of the experimental form 506 by a form filler 502. As described in connection with FIGS. 3 and 4, the data of form usage 504 is based on the interaction of the form filler 502 with the experimental form 506 and can include such data as fields used, timing on the data entry, mouse movements, keyboard entries, etc. as well as data about engagement, disengagement, and/or reengagement of the form filler 502 with the experimental form 506. The data of form usage 504 is collected using real user monitoring 512, which records and analyzes how users interact with an application, or a form, or a website, in real time. Components of the form generation and optimization system 104 described in connection with FIG. 1 perform real user monitoring ingestion 514 to store the data of form usage 504 in a user monitoring datastore 516, which is a user monitoring datastore such as user monitoring datastore 130, described in connection with FIG. 1. Components of the form generation and optimization system 104 use the data in the user monitoring datastore 516 to analyze forms, generate hypothesis, select actions, and generate form variations 518 that are used by the form manager 508 to perform further form experimentation 510.

FIG. 6 is a block diagram 600 illustrating large language model based agents and tools used in a system for generating and optimizing web forms, in accordance with implementations of the present disclosure. The LLM agents and tools component 602 is an LLM agents and tools component such as LLM agents and tools component 122, described in connection with FIG. 1.

The LLM agents and tools component 602 includes an orchestrator 604 which receives queries from other components of the system for generating and optimizing forms 104, generates prompts to the various agents and tools, and provides responses back to the other components of the system for generating and optimizing forms 104.

The LLM agents and tools component 602 includes a data query agent 606 which performs queries to a user monitoring datastore 130 to obtain form usage data, as described herein. The data query agent 606 is used by the form analysis component 114 to obtain the data used in the form analysis.

The LLM agents and tools component 602 includes a data analysis agent 608 which performs data analysis of the form usage data from the data query agent 606 to identify possible form problems and issues. The data analysis agent 608 is used by the form analysis component 116 to perform the data analysis.

The LLM agents and tools component 602 includes a form summarizer agent 610 which generates a summary or description of a form. The form summarizer agent 610 is used by the form hypothesis component 116 as the form hypothesis vector includes the form description.

The LLM agents and tools component 602 includes a hypothesis assistant 612 which generates a form hypothesis based on the problems and issues identified by the data analysis agent 608 where the form hypothesis includes the form description generated by the form summarizer agent 610, as described herein. The hypothesis assistant 612 is used by the form hypothesis component 116 to generate well-grounded hypotheses.

The LLM agents and tools component 602 includes a best practices analyzer 614 which uses historical and developed best practices to inform the development of a well-grounded hypothesis. The best practices analyzer 614 is used by the form hypothesis component 116.

The data query agent 606, the data analysis agent 608, the form summarizer agent 610, the hypothesis assistant 612, and the best practices analyzer 614 are agents and tools that perform operations to aid hypothesis development 624, helping a system for generating and optimizing web forms to develop a well-grounded hypothesis that is the basis for optimizing digital forms. As may be contemplated, other tools and agents that aid hypothesis development 624 may be considered as within the scope of the present disclosure.

The LLM agents and tools component 602 includes a field enhancer tool 616 which is used to, for example, enhance a given field by generating placeholder values for a collection of fields, as described herein. The field enhancer tool 616 can also be used to enhance fields of a form in other ways including, but not limited to, those described herein. The field enhancer tool 616 is used by the form optimization and variation component 118 to perform actions to generate form variations.

The LLM agents and tools component 602 includes a panel reorder tool 618 which is used to reorder panels of a form to improve form usability. The panel reorder tool 618 is used by the form optimization and variation component 118 to perform actions to generate form variations.

The LLM agents and tools component 602 includes a layout variation tool 620 which is used to alter the layout of a form to improve form usability. Layout alterations can include removing elements, adding elements, resizing elements, relocating elements, etc. The layout variation tool 620 is used by the form optimization and variation component 118 to perform actions to generate form variations.

The LLM agents and tools component 602 includes a style variation tool 622 which changes the style of elements of the form by, for example, using text boxes, formatted text boxes, sliders, date pickers, drop-downs, etc. as appropriate to improve form usability. The style variation tool 622 is used by the form optimization and variation component 118 to perform actions to generate form variations.

The field enhancer tool 616, the panel reorder tool 618, the layout variation tool 620, and the style variation tool 622 are tools that perform actions to generate form variations (e.g., using APIs), helping a system for generating and optimizing forms to generate form variations that are used in form experimentation to improve the digital forms.

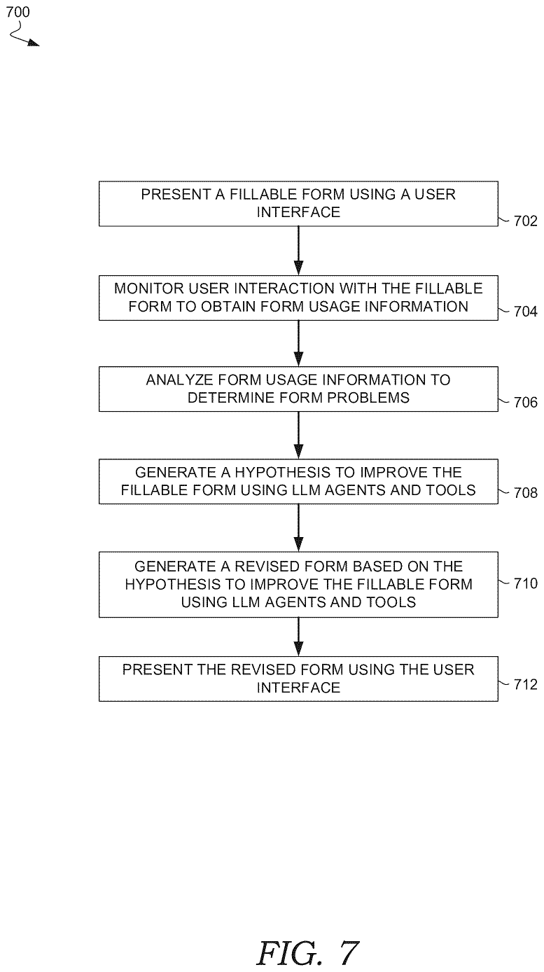

FIG. 7 is a flow diagram 700 showing an example process for generating and optimizing web forms using large language models, in accordance with some implementations of the present disclosure. The process (or method) illustrated in FIG. 7 are performed by, for instance, the form generation and optimization system 104 described herein at least in connection with FIG. 1. Each block of the method illustrated in FIG. 7 and any other methods described herein comprises a computing process performed using any combination of hardware, firmware, and/or software. For instance, various functions are carried out by a processor executing instructions stored in memory. The method or methods can also be embodied as computer-usable instructions stored on computer storage media. The methods are provided by a standalone application, a service or hosted service (standalone or in combination with another hosted service), a plug-in to another product, or other such applications, services, products, or plug-ins.

At block 702, a processing device implementing the present disclosure performs operations to present a fillable form using a user interface. As described above, the operations to present a fillable form using a user interface are performed using a user interface such as user interface 110 by a form presentation component 126 of a form generation and optimization system 104. In some aspects, the fillable form is a form of a website or other such user interface, designed to gather data (e.g., from a form filler) and store that data. In some aspects, after block 702, the process illustrated in FIG. 7 continues at block 704.

At block 704, a processing device implementing the present disclosure performs operations to monitor user interaction with the fillable form to obtain usage information. As described above, the operations to monitor user interaction with the fillable form to obtain usage information are performed by a form usage component 112 of a form generation and optimization system 104. In some aspects, the operations to monitor user interaction with the fillable form to obtain usage information are performed using real user monitoring 410, as described in connection with FIG. 4. In some aspects, after block 704, the process illustrated in FIG. 7 continues at block 706.

At block 706, a processing device implementing the present disclosure performs operations to analyze form usage information to determine form problems. As described above, the operations to analyze form usage information to determine form problems are performed by a form analysis component 114 of a form generation and optimization system 104. In some aspects, the operations to analyze form usage information to determine form problems are performed during form generation, as described at least in connection with FIG. 2 (e.g., using form analysis engine 212). In some aspects, the operations to analyze form usage information to determine form problems are performed in context of form testing and optimization, as described at least in connection with FIG. 3. In some aspects, after block 706, the process illustrated in FIG. 7 continues at block 708.

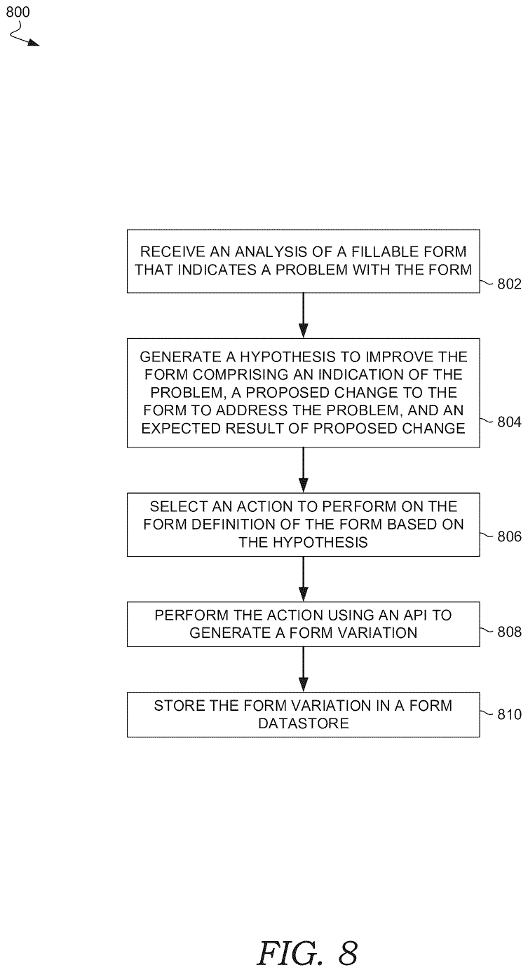

At block 708, a processing device implementing the present disclosure performs operations to generate a hypothesis to improve the fillable form using LLM agents and tools. As described above, the operations to generate a hypothesis to improve the fillable form using LLM agents and tools are performed by a form hypothesis component 116 using an LLM agents and tools component 122 of a form generation and optimization system 104. In some aspects, the operations to generate a hypothesis to improve the fillable form using LLM agents and tools are performed during form generation, as described at least in connection with FIG. 2 (e.g., using form hypothesis engine 210). In some aspects, the operations to generate a hypothesis to improve the fillable form using LLM agents and tools are performed in context of form testing and optimization, as described at least in connection with FIG. 3. More details of the operations to generate a hypothesis to improve the fillable form using LLM agents and tools are illustrated in FIG. 8. In some aspects, after block 708, the process illustrated in FIG. 7 continues at block 710.

At block 710, a processing device implementing the present disclosure performs operations to generate a revised form based on hypothesis to improve the fillable form using LLM agents and tools. As described above, the operations to generate a revised form based on hypothesis to improve the fillable form using LLM agents and tools are performed by a form optimization and variation component 118 using an LLM agents and tools component 122 of a form generation and optimization system 104. In some aspects, the operations to generate a revised form based on hypothesis to improve the fillable form using LLM agents and tools are performed during form generation, as described at least in connection with FIG. 2 (e.g., using form optimization and variation engine 208). In some aspects, the operations to generate a revised form based on hypothesis to improve the fillable form using LLM agents and tools are performed in context of form testing and optimization, as described at least in connection with FIG. 3. More details of the operations to generate a revised form based on hypothesis to improve the fillable form using LLM agents and tools are illustrated in FIG. 8. In some aspects, after block 710, the process illustrated in FIG. 7 continues at block 712.

At block 712, a processing device implementing the present disclosure performs operations to present the revised form using the user interface. As described above, the operations to present the revised form using the user interface are performed using a user interface such as user interface 110 by a form presentation component 126 of a form generation and optimization system 104. In some aspects, the user interface of block 712 is the same user interface as used at block 702 (e.g., during form generation). In some aspects, the user interface of block 712 is a different user interface that that used at block 702 when, for example, the revised form is presented to a different user. In some aspects, after block 712, the process illustrated in FIG. 7 terminates. In some aspects, not shown in FIG. 7, after block 712, the process illustrated in FIG. 7 continues at block 702, to present a new fillable form using a user interface. In some aspects, this new fillable form is another form variation of the fillable form originally presented at block 702.

Although not illustrated in FIG. 7, in some configurations, the operations of the process illustrated in FIG. 7 are performed in a different order than that described. In some configurations, where operations are performed in a different order, some of the operations is performed in parallel by a plurality of devices such as those described herein, using a plurality of threads. As may be contemplated, other orders in which to perform the operations illustrated in flow diagram 700 may be considered as within the scope of the present disclosure.

FIG. 8 is a flow diagram 800 showing an example process for performing actions to update web forms using large language models, in accordance with some implementations of the present disclosure. The example process (or method) illustrated in FIG. 8 provides more details of the example process illustrated in FIG. 7 and, in particular, of the details of blocks 708 and 710 of the process illustrated in FIG. 7. The process (or method) illustrated in FIG. 8 is performed by, for instance, the form generation and optimization system 104 described herein at least in connection with FIG. 1. Each block of the method illustrated in FIG. 8 and any other methods described herein comprises a computing process performed using any combination of hardware, firmware, and/or software. For instance, various functions are carried out by a processor executing instructions stored in memory. The method or methods can also be embodied as computer-usable instructions stored on computer storage media. The methods are provided by a standalone application, a service or hosted service (standalone or in combination with another hosted service), a plug-in to another product, or other such applications, services, products, or plug-ins.

At block 802, a processing device implementing the present disclosure performs operations to receive an analysis of a fillable form that indicates a problem with the form. As described above, the analysis of a fillable form that indicates a problem with the form are received at a form hypothesis component 116 of a form generation and optimization system 104. As described above at least in connection with FIGS. 2 and 3, the analysis of a fillable form that indicates a problem with the form is received during form generation or form optimization and is received from a form analysis component 114 using, for example, real user monitoring 410, described at least in connection with FIG. 4. In some aspects, after block 802, the process illustrated in FIG. 8 continues at block 804.

At block 804, a processing device implementing the present disclosure performs operations to generate a hypothesis to improve the form comprising an indication of the problem, a proposed change to the form to address the problem, and an expected result of proposed change. In some aspects, the operations to generate a hypothesis to improve the form comprising an indication of the problem, a proposed change to the form to address the problem, and an expected result of proposed change, generate the hypothesis using hypothesis development tools 624 of an LLM agents and tools component 602. As described above, the operations to generate a hypothesis to improve the form comprising an indication of the problem, a proposed change to the form to address the problem, and an expected result of the proposed change is performed by a form hypothesis component 116 of a form generation and optimization system 104. As described above at least in connection with FIGS. 2 and 3, the operations to generate a hypothesis to improve the form comprising an indication of the problem, a proposed change to the form to address the problem, and an expected result of the proposed change is performed during form generation or form optimization. In some aspects, after block 804, the process illustrated in FIG. 8 continues at block 806.

At block 806, a processing device implementing the present disclosure performs operations to select an action to perform on the form definition of the form based on the hypothesis. In some aspects, the operations to select an action to perform on the form definition of the form based on the hypothesis select the action using action generation tools 626 of an LLM agents and tools component 602. As described above, the operations to select an action to perform on the form definition of the form based on the hypothesis are performed by a form optimization and variation component 118 of a form generation and optimization system 104. As described above at least in connection with FIGS. 2 and 3, the selection of an action to perform on the form definition of the form based on the hypothesis is performed during form generation or form optimization. In some aspects, after block 806, the process illustrated in FIG. 8 continues at block 808.

At block 808, a processing device implementing the present disclosure performs operations to perform the action using an API to generate a form variation. As described above, the operations to perform the action using an API to generate a form variation are performed by a form optimization and variation component 118 of a form generation and optimization system 104. As described above at least in connection with FIGS. 2 and 3, the operations to perform the action using an API to generate a form variation are performed during form generation or form optimization. In some aspects, after block 808, the process illustrated in FIG. 8 continues at block 810.

At block 810, a processing device implementing the present disclosure performs operations to store the form variation in a form datastore. As described above, the operations to store the form variation in a form datastore are performed by a form optimization and variation component 118 and/or by a form manager component 120 of a form generation and optimization system 104 and the form variation is stored in a form data store 128. In some aspects, after block 810, the process illustrated in FIG. 8 terminates. In some aspects, not shown in FIG. 8, after block 810, the process illustrated in FIG. 8 continues at block 802, to receive another analysis of this or another fillable form that indicates a problem with the form.

Although not illustrated in FIG. 8, in some configurations, the operations of the process illustrated in FIG. 8 are performed in a different order than that described. In some configurations, where operations are performed in a different order, some of the operations is performed in parallel by a plurality of devices such as those described herein, using a plurality of threads. As may be contemplated, other orders in which to perform the operations illustrated in flow diagram 800 may be considered as within the scope of the present disclosure.

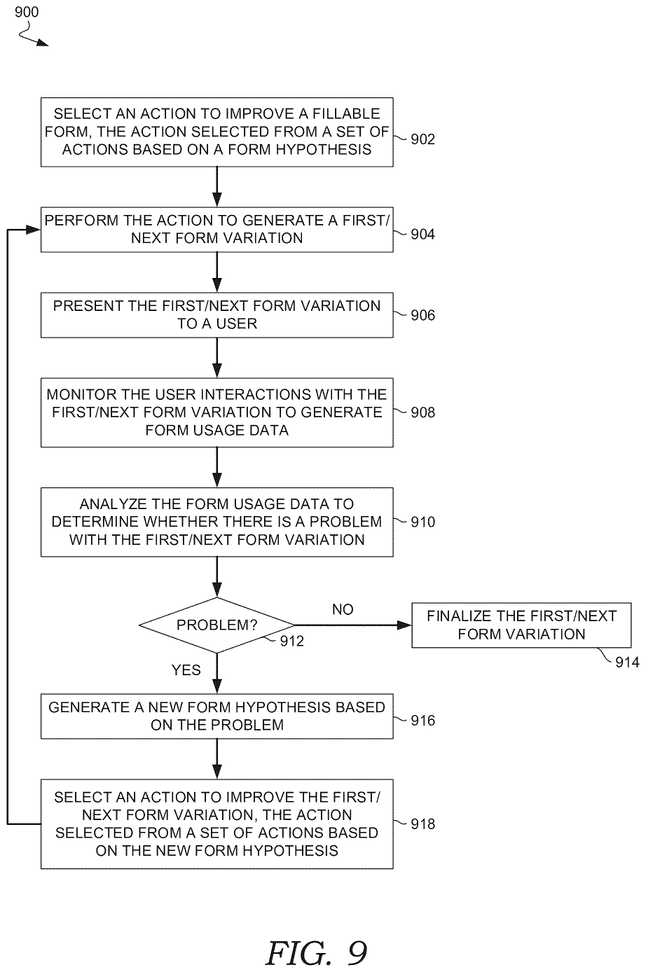

FIG. 9 is a flow diagram 900 showing an example process for performing experimentation to generate and optimize web forms using large language models, in accordance with some implementations of the present disclosure. As described herein, the process (or method) illustrated in FIG. 9 is performed in connection with form experimentation, as described in connection with FIG. 5. The process (or method) illustrated in FIG. 9 is performed using the fillable form presented at block 702 of process 700, the revised form presented at block 712 of process 700, the form variation stored in a datastore at block 810 of process 810, and/or other such forms including, but not limited to those described herein. The process (or method) illustrated in FIG. 9 is performed by, for instance, the form generation and optimization system 104 described herein at least in connection with FIG. 1. Each block of the method illustrated in FIG. 9 and any other methods described herein comprises a computing process performed using any combination of hardware, firmware, and/or software. For instance, various functions are carried out by a processor executing instructions stored in memory. The method or methods can also be embodied as computer-usable instructions stored on computer storage media. The methods are provided by a standalone application, a service or hosted service (standalone or in combination with another hosted service), a plug-in to another product, or other such applications, services, products, or plug-ins.

At block 902, a processing device implementing the present disclosure performs operations to select an action to improve a fillable form, the action selected from a set of actions based on a form hypothesis. As described above, the operations to select an action to improve a fillable form, the action selected from a set of actions based on a form hypothesis is performed using the fillable form presented at block 702 of process 700, the revised form presented at block 712 of process 700, the form variation stored in a datastore at block 810 of process 810, and/or other such forms and the form hypothesis is a hypothesis generated with respect to those forms (e.g., at block 708 of process 700, block 804 of process 800, a hypothesis generated from the form variation stored at block 810 of process 800, and/or other hypothesis of other such forms). As described above, the operations to select an action to improve a fillable form, the action selected from a set of actions based on a form hypothesis are performed by a form optimization and variation component 118 using an LLM agents and tools component 122, of the form generation and optimization system 104. As described above, the operations to select an action to improve a fillable form, the action selected from a set of actions based on a form hypothesis and are performed in connection with form experimentation, as described at least in connection with FIG. 5. In some aspects, after block 902, the process illustrated in FIG. 9 continues at block 904.

At block 904, a processing device implementing the present disclosure performs operations to perform the action to generate a form variation. As described above, the operations to perform the action to generate a form variation are performed by a form optimization and variation component 118 or a form manager component 120 using one or more APIs. As described above, the operations to perform the action to generate a form variation are performed during and are performed in connection with form experimentation, as described at least in connection with FIG. 5. In some aspects, after block 904, the process illustrated in FIG. 9 continues at block 906.

At block 906, a processing device implementing the present disclosure performs operations to present the form variation to a user. As described above, the operations to present the form variation to a user are performed by a form generation and optimization system 104 using a user interface such as user interface 110. In some aspects, the form variation is presented to a form filler such as form filler 502, for form experimentation as described at least in connection with FIG. 5. In some aspects, after block 906, the process illustrated in FIG. 9 continues at block 908.

At block 908, a processing device implementing the present disclosure performs operations to monitor the user interactions with the form variation to generate form usage data. As described above, the operations to monitor the user interactions with the form variation to generate form usage data are performed using real user monitoring 512 and ingested using real user monitoring ingestion 514, both described at least in connection with FIG. 5. Although not shown in FIG. 9, in some aspects, the monitored user interactions are stored in a usage datastore such as user monitoring datastore 516, described at least in connection with FIG. 5. In some aspects, after block 908, the process illustrated in FIG. 9 continues at block 910.

At block 910, a processing device implementing the present disclosure performs operations to analyze the form usage data to determine whether there is a problem with the form variation. As described above, the operations to analyze the form usage data to determine whether there is a problem with the form variation are performed by a form analysis component 114 and a form experimentation component 124 of the form generation and optimization system 104. In some aspects, the operations to analyze the form usage data to determine whether there is a problem with the form variation are performed using one or more LLM agents and tools 122. In some aspects, after block 910, the process illustrated in FIG. 9 continues at block 912.

At block 912, a processing device implementing the present disclosure performs operations to determine whether there is a problem with the form variation. As described above, the operations to determine whether there is a problem with the form variation are performed using results from the form analysis at block 910. If it is determined that there is a problem with the form variation (“YES” branch), the process illustrated in FIG. 9 continues at block 916. If it is determined that there is not a problem with the form variation (“NO” branch), the process illustrated in FIG. 9 continues at block 914.

At block 914, a processing device implementing the present disclosure performs operations to finalize the form variation. As described above, the operations to finalize the form variation are performed as a result of determining (e.g., at block 912) that the form has no problems and is finalized for use by form fillers. In some aspects, the operations to finalize the form variation are performed by a form manager component 120 of a form generation and optimization system 104. In some aspects, after block 914, the process illustrated in FIG. 9 terminates. In some aspects, not shown in FIG. 9, after block 914, the process illustrated in FIG. 9 continues at block 902, to select another action to improve a fillable form (e.g., this or another form).

At block 916, a processing device implementing the present disclosure performs operations to generate a new form hypothesis based on the problem. As described above, the operations to generate a new form hypothesis based on the problem are performed using a form hypothesis component 116 using and LLM agents and tools component 122 of a form generation and optimization system 104. In some aspects, after block 916, the process illustrated in FIG. 9 continues at block 918.

At block 918, a processing device implementing the present disclosure performs operations to select an action to improve the form variation, the action selected from a set of actions based on the new form hypothesis. As described above, the operations to select an action to improve the form variation, the action selected from a set of actions based on the new form hypothesis are performed by a form optimization and variation component 118 and an LLM agents and tools component 122 of a form generation and optimization system 104. In some aspects, after block 918, the process illustrated in FIG. 9 continues at block 904 to perform the selected action to generate the next form variation.

Although not illustrated in FIG. 9, in some configurations, the operations of the process illustrated in FIG. 9 are performed in a different order than that described. In some configurations, where operations is performed in a different order, some of the operations is performed in parallel by a plurality of devices such as those described herein, using a plurality of threads. As may be contemplated, other orders in which to perform the operations illustrated in flow diagram 900 may be considered as within the scope of the present disclosure.

### Training: Machine Learning

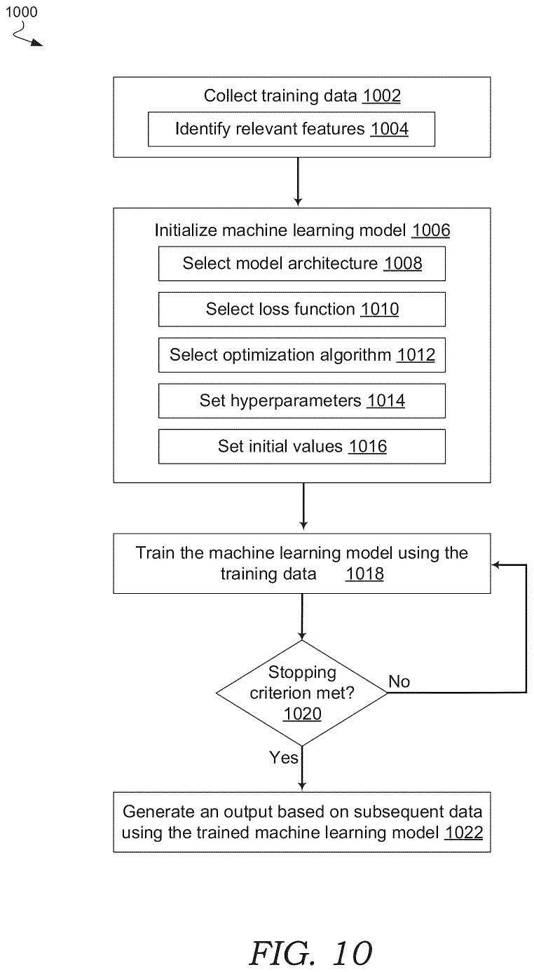

FIG. 10 is a flow diagram depicting an algorithm as a step-by-step procedure 1000 in an example implementation of operations performable for training a machine-learning model. In some embodiments, the procedure 1000 describes an operation of a training component used to train aspects of the form generation and optimization system 104 described in connection with FIG. 1. The procedure 1000 provides one or more examples of generating training data, use of the training data to train a machine-learning model, and use of the trained machine-learning model to perform a task.

To begin in this example, a machine-learning system collects training data (block 1002) that is to be used as a basis to train a machine-learning model, i.e., which defines what is being modeled. The training data is collectable by the machine-learning system from a variety of sources. Examples of training data sources include public datasets, service provider system platforms that expose application programming interfaces (e.g., social media platforms), user data collection systems (e.g., digital surveys and online crowdsourcing systems), and so forth. Training data collection may also include data augmentation and synthetic data generation techniques to expand and diversify available training data, balancing techniques to balance a number of positive and negative examples, and so forth.

The machine-learning system is also configurable to identify features that are relevant (block 1004) to a type of task, for which the machine-learning model is to be trained. Task examples include classification, natural language processing, generative artificial intelligence, recommendation engines, reinforcement learning, clustering, and so forth. To do so, the machine-learning system collects the training data based on the identified features and/or filters the training data based on the identified features after collection. The training data is then utilized to train a machine-learning model.

In order to train the machine-learning model in the illustrated example, the machine-learning model is first initialized (block 1006). Initialization of the machine-learning model includes selecting a model architecture (block 1008) to be trained. Examples of model architectures include neural networks, convolutional neural networks (CNNs), long short-term memory (LSTM) neural networks, generative adversarial networks (GANs), decision trees, support vector machines, linear regression, logistic regression, Bayesian networks, random forest learning, dimensionality reduction algorithms, boosting algorithms, deep learning neural networks, etc.

A loss function is also selected (block 1010). The loss function is utilized to measure a difference between an output of the machine-learning model (i.e., predictions) and target values (e.g., as expressed by the training data) to be used to train the machine-learning model. Additionally, an optimization algorithm is selected (block 1012) that is to be used in conjunction with the loss function to optimize parameters of the machine-learning model during training, examples of which include gradient descent, stochastic gradient descent (SGD), and so forth.

Initialization of the machine-learning model further includes setting initial values of the machine-learning model (block 1014) examples of which includes initializing weights and biases of nodes to improve efficiency in training and computational resources consumption as part of training. Hyperparameters are also set that are used to control training of the machine learning model, examples of which include regularization parameters, model parameters (e.g., a number of layers in a neural network), learning rate, batch sizes selected from the training data, and so on. The hyperparameters are set using a variety of techniques, including use of a randomization technique, through use of heuristics learned from other training scenarios, and so forth.

The machine-learning model is then trained using the training data (block 1018) by the machine-learning system. A machine-learning model refers to a computer representation that is tuned (e.g., trained and retrained) based on inputs of the training data to approximate unknown functions. In particular, the term machine-learning model can include a model that utilizes algorithms (e.g., using the model architectures described above) to learn from, and make predictions on, known data by analyzing training data to learn and relearn to generate outputs that reflect patterns and attributes expressed by the training data.

Examples of training types include supervised learning that employs labeled data, unsupervised learning that involves finding an underlying structures or patterns within the training data, reinforcement learning based on optimization functions (e.g., rewards and/or penalties), use of nodes as part of “deep learning,” and so forth. The machine-learning model, for instance, is configurable as including a plurality of nodes that collectively form a plurality of layers. The layers, for instance, are configurable to include an input layer, an output layer, and one or more hidden layers. Calculations are performed by the nodes within the layers through the hidden states through a system of weighted connections that are “learned” during training, e.g., through use of the selected loss function and backpropagation to optimize performance of the machine-learning model to perform an associated task.

As part of training the machine-learning model, a determination is made as to whether a stopping criterion is met (decision block 1020), i.e., which is used to validate the machine-learning model. The stopping criterion is usable to reduce overfitting of the machine-learning model, reduce computational resource consumption, and promote an ability of the machine-learning model to address previously unseen data, i.e., that is not included specifically as an example in the training data. Examples of a stopping criterion include but are not limited to a predefined number of epochs, validation loss stabilization, achievement of a performance improvement threshold, whether a threshold level of accuracy has been met, or based on performance metrics such as precision and recall. If the stopping criterion has not been met (“no” from decision block 1020), the procedure 1000 continues training of the machine-learning model using the training data (block 1018) in this example.

If the stopping criterion is met (“yes” from decision block 1020), the trained machine-learning model is then utilized to generate an output based on subsequent data (block 1022). The trained machine-learning model, for instance, is trained to perform a task as described above and therefore once trained is configured to perform that task based on subsequent data received as an input and processed by the machine-learning model.

### System: Computing Device

Having described implementations of the present disclosure, an exemplary operating environment in which embodiments of the present technology is implemented is described below in order to provide a general context for various aspects of the present disclosure. Referring initially to FIG. 11 in particular, an exemplary operating environment for implementing embodiments of the present technology is shown and designated generally as computing device 1100. Computing device 1100 is but one example of a suitable computing environment and is not intended to suggest any limitation as to the scope of use or functionality of the technology. Neither should the computing device 1100 be interpreted as having any dependency or requirement relating to any one or combination of components illustrated.

The technology is described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The technology is practiced in a variety of system configurations, including hand-held devices, consumer electronics, general-purpose computers, more specialty computing devices, etc. The technology can also be practiced in distributed computing environments where tasks are performed by remote-processing devices that are linked through a communications network.

FIG. 11 shows an example of a computing device 1100 according to aspects of the present disclosure. The computing device 1100 may be an example of a computing device used to implement one or more aspects of the form generation and optimization system 104 described in connection with FIG. 1. In one aspect, computing device 1100 includes processor(s) 1105, memory subsystem 1110, communication interface 1115, I/O interface 1120, user interface component(s) 1125, and channel 1130.

In some embodiments, computing device 1100 is an example of, or includes aspects of, the form generation and optimization system 104 described in connection with FIG. 1. In some embodiments, computing device 1100 includes one or more processors 1105 that can execute instructions stored in memory subsystem 1110 to perform media generation.

According to some aspects, computing device 1100 includes one or more processors 1105. In some cases, a processor is an intelligent hardware device, (e.g., a general-purpose processing component, a digital signal processor (DSP), a central processing unit (CPU), a graphics processing unit (GPU), a microcontroller, an application specific integrated circuit (ASIC), a field programmable gate array (FPGA), a programmable logic device, a discrete gate or transistor logic component, a discrete hardware component, or a combination thereof. In some cases, a processor is configured to operate a memory array using a memory controller. In other cases, a memory controller is integrated into a processor. In some cases, a processor is configured to execute computer-readable instructions stored in a memory to perform various functions. In some embodiments, a processor includes special purpose components for modem processing, baseband processing, digital signal processing, or transmission processing.

According to some aspects, memory subsystem 1110 includes one or more memory devices. Examples of a memory device include random access memory (RAM), read-only memory (ROM), or a hard disk. Examples of memory devices include solid state memory and a hard disk drive. In some examples, memory is used to store computer-readable, computer-executable software including instructions that, when executed, cause a processor to perform various functions described herein. In some cases, the memory contains, among other things, a basic input/output system (BIOS) which controls basic hardware or software operation such as the interaction with peripheral components or devices. In some cases, a memory controller operates memory cells. For example, the memory controller can include a row decoder, column decoder, or both. In some cases, memory cells within a memory store information in the form of a logical state.

According to some aspects, communication interface 1115 operates at a boundary between communicating entities (such as computing device 1100, one or more user devices, a cloud, and one or more databases) and channel 1130 and can record and process communications. In some cases, communication interface 1115 is provided to enable a processing system coupled to a transceiver (e.g., a transmitter and/or a receiver). In some examples, the transceiver is configured to transmit (or send) and receive signals for a communications device via an antenna.

According to some aspects, I/O interface 1120 is controlled by an I/O controller to manage input and output signals for computing device 1100. In some cases, I/O interface 1120 manages peripherals not integrated into computing device 1100. In some cases, I/O interface 1120 represents a physical connection or port to an external peripheral. In some cases, the I/O controller uses an operating system such as iOS®, ANDROID®, MS-DOS®, MS-WINDOWS®, OS/2®, UNIX®, LINUX®, or other known operating system. In some cases, the I/O controller represents or interacts with a modem, a keyboard, a mouse, a touchscreen, or a similar device. In some cases, the I/O controller is implemented as a component of a processor. In some cases, a user interacts with a device via I/O interface 1120 or via hardware components controlled by the I/O controller.

According to some aspects, user interface component(s) 1125 enable a user to interact with computing device 1100. In some cases, user interface component(s) 1125 include an audio device, such as an external speaker system, an external display device such as a display screen, an input device (e.g., a remote-control device interfaced with a user interface directly or through the I/O controller), or a combination thereof. In some cases, user interface component(s) 1125 include a GUI.

The present technology has been described in relation to particular embodiments, which are intended in all respects to be illustrative rather than restrictive. Alternative embodiments will become apparent to those of ordinary skill in the art to which the present technology pertains without departing from its scope.

Having identified various components utilized herein, it should be understood that any number of components and arrangements is employed to achieve the desired functionality within the scope of the present disclosure. For example, the components in the embodiments depicted in the figures are shown with lines for the sake of conceptual clarity. Other arrangements of these and other components can also be implemented. For example, although some components are depicted as single components, many of the elements described herein is implemented as discrete or distributed components or in conjunction with other components, and in any suitable combination and location. Some elements are omitted altogether. Moreover, various functions described herein as being performed by one or more entities is carried out by hardware, firmware, and/or software, as described below. For instance, various functions are carried out by a processor executing instructions stored in memory. As such, other arrangements and elements (e.g., machines, interfaces, functions, orders, and groupings of functions) is used in addition to or instead of those shown.

Embodiments described herein is combined with one or more of the specifically described alternatives. In particular, an embodiment that is claimed can contain a reference, in the alternative, to more than one other embodiment. The embodiment that is claimed can specify a further limitation of the subject matter claimed.

The subject matter of embodiments of the technology is described with specificity herein to meet statutory requirements. However, the description itself is not intended to limit the scope of this patent. Rather, the inventors have contemplated that the claimed subject matter can also be embodied in other ways, to include different steps or combinations of steps similar to the ones described in this document, in conjunction with other present or future technologies. Moreover, although the terms “step” and/or “block” is used herein to connote different elements of methods employed, the terms should not be interpreted as implying any particular order among or between various steps herein disclosed unless and except when the order of individual steps is explicitly described.

For purposes of this disclosure, the word “including” has the same broad meaning as the word “comprising,” and the word “accessing” comprises “receiving,” “referencing,” or “retrieving.” Further, the word “communicating” has the same broad meaning as the word “receiving,” or “transmitting” facilitated by software or hardware-based buses, receivers, or transmitters using communication media described herein. In addition, words such as “a” and “an,” unless otherwise indicated to the contrary, include the plural as well as the singular. Thus, for example, the constraint of “a feature” is satisfied where one or more features are present. Also, the term “or” includes the conjunctive, the disjunctive, and both (a or b thus includes either a or b, as well as a and b).

For purposes of a detailed discussion above, embodiments of the present technology are described with reference to a distributed computing environment; however, the distributed computing environment depicted herein is merely exemplary. Components is configured for performing novel embodiments of embodiments, where the term “configured for” can refer to “programmed to” perform particular tasks or implement particular abstract data types using code. Further, while embodiments of the present technology can generally refer to the technical solution environment and the schematics described herein, it is understood that the techniques described is extended to other implementation contexts.

From the foregoing, it will be seen that this technology is one well adapted to attain all the ends and objects set forth above, together with other advantages which are obvious and inherent to the system and method. It will be understood that certain features and subcombinations are of utility and is employed without reference to other features and subcombinations. This is contemplated by and is within the scope of the claims.

What is claimed is:

1. A computer-implemented method comprising:
causing presentation, using a form presentation component, of a fillable form;
monitoring, using a form usage component, user interaction with the fillable form to obtain form usage information;
analyzing, using a form analysis component, the form usage information to determine a form problem;
generating, using a form hypothesis component, a form hypothesis to improve the fillable form using a first set of large language model agents;
generating, using a form variation and optimization component, a revised form based, at least in part, on the form hypothesis and using a second set of language model agents; and
causing presentation, using the form presentation component, of the revised form.

2. The computer-implemented method of claim 1, wherein the form hypothesis comprises an indication of the form problem, a proposed change to the fillable form to address the form problem, and an expected result of the proposed change.

3. The computer-implemented method of claim 1, wherein generating the revised form comprises:
selecting an action from a set of actions to perform on the fillable form based at least in part on the form hypothesis and using the second set of large language model agents; and
performing the action on the fillable form to generate the revised form.

4. The computer-implemented method of claim 3, wherein performing the action on the fillable form comprises performing an application programming interface (API) of an API library of a form manager component.

5. The computer-implemented method of claim 3, wherein:
the fillable form is a blank form presented to a form author;
the set of actions is presented to the form author; and
the form author provides input that is used by the form variation and optimization component to select the action from the set of actions.

6. The computer-implemented method of claim 1, further comprising:
storing a form definition of the revised form in a form datastore using an API of an API library of a form manager component.

7. The computer-implemented method of claim 1, further comprising:
monitoring, using the form usage component, user interaction with the revised form to obtain revised form usage information;
analyzing, using the form analysis component, the revised form usage information to determine a revised form problem;
generating, using the form hypothesis component, a revised form hypothesis to improve the revised form using the first set of large language model agents;
generating, using the form variation and optimization component, a new revised form based, at least in part on the form hypothesis and using the second set of large language model agents; and
presenting, using the form presentation component, the new revised form.

8. The computer-implemented method of claim 1, wherein the form usage component uses real user monitoring (RUM) to obtain the form usage information.

9. The computer-implemented method of claim 1, wherein:
the form usage information is stored in a usage datastore by the form usage component; and
the first set of large language model agents are used by the form hypothesis component to generate the form hypothesis to improve the fillable form based, at least in part, on performing a query to the form datastore for the form usage information.

10. The computer-implemented method of claim 1, wherein
the fillable form is a blank form presented to a form author; and
the form author provides input that is used by the form hypothesis component and the first set of large language model agents to generate the form hypothesis.

11. One or more computer storage media storing computer-useable instructions that, when used by one or more computing devices, cause the one or more computing devices to perform operations, the operations comprising:
obtaining a form definition from a form datastore;
causing presentation of a digital form based, at least in part, on the form
definition;
storing form user interaction associated with the digital form in a usage datastore;
analyzing the form usage information to generate a form hypothesis using a first set of large language model agents, the form hypothesis at least comprising an indication of a form problem, a proposed change to the digital form to address the form problem, and an expected result of the proposed change;
generating a revised form definition by performing one or more actions selected from a set of actions obtained from a second set of large language model agent, the one or more actions selected based, at least in part, on the form hypothesis; and
storing the revised form definition in the form datastore.

12. The one or more computer storage media of claim 11, wherein performing one or more actions comprises performing an application programming interface (API) of an API library provided by a form manager.

13. The one or more computer storage media of claim 11, wherein:
the digital form is presented to a first form filler using a first user interface;
a second digital form is generated from the revised form definition and presented to a second form filler to store additional form usage information with the second digital form in the usage datastore; and
the form hypothesis is generated based, at least in part, on differences between the form usage information and the additional form usage information.

14. The one or more computer storage media of claim 11, wherein the form hypothesis is generated based, at least in part, on known best practices.

15. The one or more computer storage media of claim 11, wherein the operations further comprise evaluating the relevance of the form hypothesis based, at least in part, on a few-shot generation technique generation technique that stores a form profile in the vector store comprising the form definition, the form hypothesis, and the one or more actions and compares the first form profile to one or more second form profiles.

16. The one or more computer storage media of claim 12, wherein the few-shot generation technique uses hypotheses retrieved from the vector store using retrieval augmented generation (RAG).

17. A computer system comprising:
one or more processors; and
one or more computer storage media storing computer-useable instructions that, when used by the one or more processors, causes the computer system to perform operations comprising:
obtaining a form definition from a form datastore;
presenting a digital form based, at least in part, on the form definition;
storing form user interaction with the digital form in a usage datastore;
analyzing the form usage information to generate a form hypothesis using a first set of large language model agents, the form hypothesis at least comprising an indication of a form problem, a proposed change to the digital form to address the form problem, and an expected result of the proposed change;
generating a revised form definition by performing one or more actions selected from a set of actions obtained from a second set of large language model agents, the one or more actions selected based, at least in part, on the form hypothesis; and
storing the revised form definition in the form datastore.

18. The computer system of claim 17, wherein the operations further comprise:
using the form hypothesis component to perform hypothesis ideation by refining the form hypothesis to generating a refined form hypothesis;
generating a new revised form definition by performing one or more new actions selected from the set of actions obtained from the second set of large language model agents, the one or more new actions selected based, at least in part, on the refined form hypothesis; and
storing the new revised form definition in the form datastore.

19. The computer system of claim 17, wherein the operations further comprise:
comparing the form user interaction with the digital form with one or more other form user interactions obtained from the usage store to generate a comparison result; and
using the comparison result to generate the form hypothesis.

20. The computer system of claim 17, wherein the operations further comprise:
presenting a revised digital form based, at least in part, on the revised form definition;
storing form user interaction with the revised digital form in the usage datastore;
analyzing the revised form usage information to generate a revised form hypothesis using the first set of large language model agents;
generating a new revised form definition by performing one or more actions selected from a second set of actions obtained from the second set of large language model agents, the one or more actions selected based, at least in part, on the revised form hypothesis; and
storing the new revised form definition in the form datastore.
